(19) United States
(12) Patent Application Publication
(10) Pub. No.: US 2006/0143126 A1
(43) Pub. Date: Jun. 29, 2006

(54) Systems and processes for self-healing an identity store

(75) Inventors: Karan Vasishth, Redmond, WA (US); Kimberley Ann Hunter, Snoqualmie, WA (US); Laurie A. Brown, Stanwood, WA (US); Mark David Lawrence, Duvall, WA (US); Matthias Leibmann, Woodinville, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/021,865

(22) Filed: Dec. 23, 2004

(51) Int. Cl. G06Q 99/00

(52) U.S. Cl. 705/51

(57) ABSTRACT

A system includes a working state of an identity store having an account object, definitive state data having an account object in a known state, and a consistency checking module operable to determine whether the account object in the working state is consistent with the account object in the definitive state. The system also includes a self-healing module operable to manage the lifecycle of objects in the working state of the identity store. A method includes detecting an inconsistency between an account object in a definitive state repository and a corresponding account object in a working state repository, and generating an alert based on the detecting of the inconsistency.

### CROSS-REFERENCE TO RELATED APPLICATIONS

The present application is related to concurrently filed U.S. patent application Ser. No. ______ entitled “SYSTEMS AND PROCESSES FOR FACILITATING POLICY CHANGE”, U.S. patent application Ser. No. ______ entitled “SCHEMA CHANGE GOVERNANCE FOR IDENTITY STORE”, and U.S. patent application Ser. No. ______ entitled “MANAGING ELEVATED PRIVILEGES IN AN IDENTITY STORE”, which are assigned to the Assignee of the present application, and incorporated herein by reference for all that they disclose.

### BACKGROUND

Corporations and other organizations typically include a network and identity repository for keeping track of organizational resources. For example, a directory can be used to store data that represents computers, employees, user accounts, application programs and other real-world entities, so that such organizational entities can be identified, tracked and managed. In large organizations identity information may be distributed across many systems in many domains. The manner in which the identity information is defined is important to ensure effective, efficient, stable and secure day-to-day operations.

One example of an identity store is ACTIVE DIRECTORY from MICROSOFT CORPORATION. ACTIVE DIRECTORY employs objects that represent real-life entities, such as users, user accounts, computers, and so on. The objects typically have associated lifecycles and states related to the duration and status of entities within the network. Good lifecycle management processes for ACTIVE DIRECTORY objects is important for ensuring the security and stability of a network. For example, an inactive account, if not monitored, can be used maliciously to harm the network. In addition, if not managed carefully, inconsistencies can arise among objects in the ACTIVE DIRECTORY that can be a source of instability or insecurity.

To date, lifecycle management has been largely a manual process driven by corporate security, business, and legal requirements. The process has been managed through a series of scripts and ad hoc queries. Traditional approaches are typically reactive in nature and require human intervention, which can therefore be subject to human error. Inconsistencies in account information are often found hours, even days, after the account modification has occurred. If the indication of the modification is not well understood by the operator responsible for manually correcting issues, serious security issues can go undetected.

### SUMMARY

Implementations describe herein provide automated methods and systems for identifying inactive accounts, and identifying and correcting inconsistencies between a working state and a definitive state of the identity store. An alert is generated regarding the inconsistency. The alert includes information that can be used by a technical or security staff to determine the cause of the inconsistency. Objects in the working state can be automatically updated to be consistent with corresponding objects in the definitive state. A historical record can be automatically maintained of all transactions performed.

### BRIEF DESCRIPTION OF THE FIGURES

FIG. 1 illustrates an exemplary system for automatically detecting, auditing, alerting, correcting inconsistencies and reporting between a definitive state of an identity store and a working state of an identity store;

FIGS. 2-3 illustrate an exemplary algorithm for automatically detecting and correcting inconsistencies between a definitive state of an identity store and a working state of an identity store;

FIG. 4 illustrates an exemplary algorithm for managing a lifecycle and alerting inconsistencies of an object in an identity store;

FIG. 5 illustrates a general purpose computer that can be used to implement the exemplary identity store self-healing processes and systems described herein.

### DETAILED DESCRIPTION

An identity system includes identity data representing real-world entities relevant to a corporation, or other organization. Real-world entities include, but are not limited to, human users, user accounts, resources, role, files, application programs, computers, and network appliances. The identity system enables the organization to identify the real-world entities and maintain attribute information descriptive of the real-world entities. Preferably, the identity system also allows for higher-level functions, such as, secure access to, and tracking use of, the real-world entities.

The identity data can be embodied as one or more objects, wherein each object represents a real-world entity. User account objects include attributes, such as user name, password, access privilege level, and so on, which describe corresponding user accounts. Account objects may reside in different domains within the organization. For example, account objects for staff residing in Europe may be contained within a unique domain.

In each domain, the account objects can typically be changed by a user with sufficient rights to change user accounts. Such changes to account objects may or may not be consistent with organization policy or procedure. Changes to account objects may result in improper or accidental deletion or modification of said account object. In addition, an account object that is inactive for prolonged period of time can pose a security threat to the network.

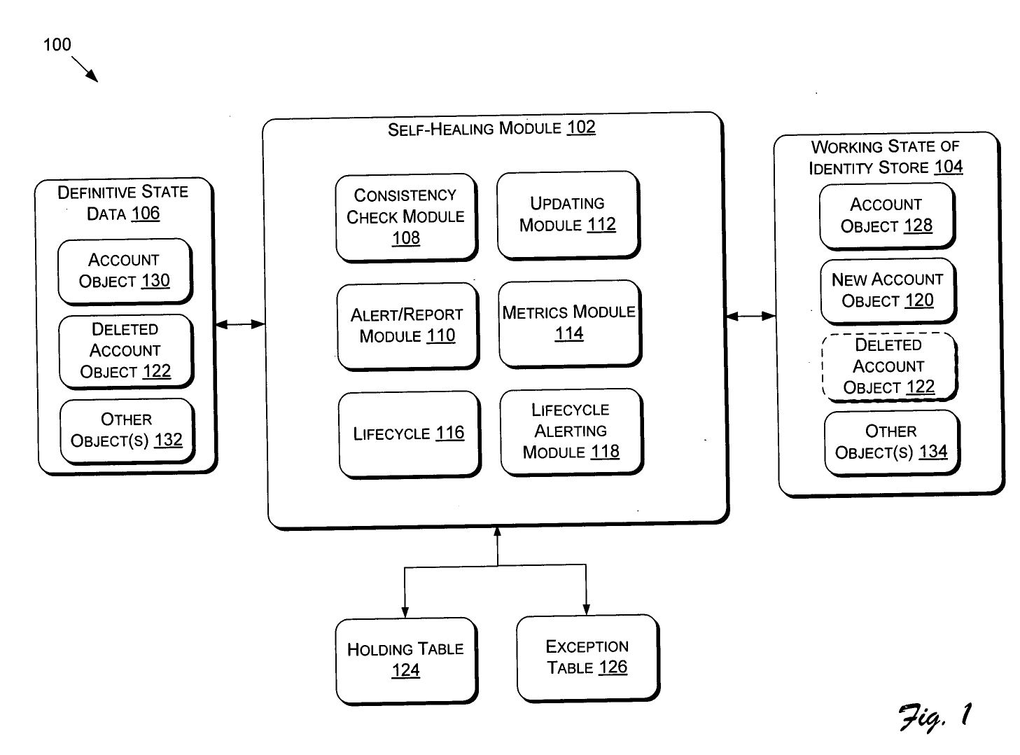

FIG. 1 illustrates an exemplary system 100 for self-healing objects in an identity store. Self-healing refers to various processes of correcting errors in an identity store, including, but not limited to, automatically detecting and correcting inconsistencies between a definitive state of the identity store and a working state of the identity store, generating an alert or providing a report when an inconsistency is detected, determining when an account object has been inactive for a specified length of time, and generating an alert when an account object has been inactive for a specified length of time.

A working state of the identity store 104 is potentially dynamic. This means that objects in the working state 104 can change, the self healing system and processes must appropriately to all changes. Changes to the working state of the identity store 104 may or may not be compliant with policy or may or may not be correct. As such, the working state of the identity store 104 is analyzed from time to time with respect to definitive state data 106. The definitive state data 106 is a baseline or known state of the identity store from which the consistency of the working state 104 can be measured.

A self-healing module 102 checks consistency between the working state of the identity store 104 and the definitive state data 106. The self-healing module 102 also performs lifecycle management functions to manage the lifecycle of objects in the working state of the identity store 104. The self-healing module 102 performs consistency checking using a consistency check module 108, a consistency alert/report module 110, an updating module 112, and a metrics module 114. The self-healing module 102 includes a lifecycle analysis module 116 and a lifecycle alerting module 118 for performing lifecycle management of user accounts.

The consistency checking module 108 reads the object from the working state of the identity store 104 and the corresponding object (if one exists) determines consistency between the two objects. Any differences are considered inconsistencies between the account objects.

The consistency checking module 108 also searches the working state 104 for non-corresponding objects 118. For example, a new, unauthorized account object 120 is any account object that exists in the working state identity store 104 for which no corresponding account object exists in the definitive state identity store 106. The consistency check module 108 also searches the definitive state data 106 for any deleted account objects 122. A deleted account object 122 is an account object that is in the definitive state data 106, for which no corresponding account object exists in the working state 104.

In accordance with one implementation, any non-corresponding working state objects are identified and placed in a holding table 124 where they can be analyzed later. The holding table 124 stores some identifier corresponding to each or new account object 120 or deleted account object 122 and/or the deleted and new account objects themselves. An indicator for each account object identified in the holding table 124 indicates whether the account object is new or deleted.

In accordance with one implementation, an exception table 126 includes exceptions related to organizational policies. For example, if an organizational policy states that an account type should not have RAS access, but an exception is given, an exception in the exception table 126 would supersede the organizational policy and an account object would be enabled for RAS access. Such exceptions are used by the consistency checking module 108 to determine whether an identified inconsistency is acceptable.

An alert/report module 110 generates alerts and reports when inconsistencies are identified. In one implementation of the alert/report module 110, an email is sent to a specified administrator when an inconsistency is identified. The metrics module 114 maintains data related to the consistency checking process. Various exemplary metrics that can be calculated and stored by the metrics module 114 includes, but is not limited to, percentage of unauthorized changes detected and resolved within a specified time, percentage of account objects in working state not in definitive state. The metrics module 114 can also automatically maintain a detailed historical record of all transactions performed, such as all updates to account objects in the working state 104 or all updates to account objects in the definitive state 106.

The lifecycle management module 116 of the self-healing module 102 analyzes the viability of the objects in the identity store 104. The lifecycle management module 116 takes actions with respect to working state account objects 128 based on periods of inactivity of the account object. The lifecycle management module 116 identifies the last time the user logged onto the network to determine whether or not the account is still active. In a particular implementation, an attribute called “lastlogontimestamp” is obtained from the account object 128, which indicates the last time the user logged on to the account.

After obtaining the time of the last logon, implementations of the lifecycle management module 116 take different actions depending on whether the account is inactive and/or the length of time that the account object has been inactive. In one implementation, if the account object 128 is inactive (i.e., unused) for a specified period of time (e.g., 3 months), the account object is automatically deleted.

Another implementation of the lifecycle management module 116 does not immediately delete an inactive account object 128, but rather determines whether the inactivity is justified and/or monitors the account for an additional period prior to deleting the account. For example, the lifecycle management module 116 can determine if an account object has been inactive because the user is on a leave of absence (LOA) or sabbatical. In such cases, the inactivity is considered justified and the account object 128 will not be deleted.

If the inactivity is not justified, the foregoing implementation of the lifecycle management module 116 puts the account object into a monitoring state called quarantine. Quarantine lasts for up to a specified period of time. During quarantine, the account object is checked to determine if activity has resumed. If the activity resumes during quarantine, the account is removed from quarantine, but not deleted.

However, if the quarantine period passes without account object activity resuming, the lifecycle management module 116 disables the user account. When an account object is disabled, the user must contact the system administrator or other responsible personnel in order to get the account object re-enabled. If the user does not take action to get the account object re-enabled, after a specified period of time, the account object is deleted.

If the lifecycle management module 116 takes an action with respect to an account object 128 (e.g., quarantine, disable, or delete) or detects inactivity of a user account, the lifecycle alerting module 118 notifies appropriate user (e.g., systems administrator) of the event. The lifecycle alerting module 118 can communicate the notification in any number of ways, including, but not limited to, email. When the notified user receives the alert, the inactive user account can be investigated further for business viability.

The definitive state data 106 can include one or more other user account objects 130 as well as other objects 132. Likewise, the working state of the identity store 104 can include other objects 134.

Modules (e.g. self-healing module 102, consistency check module 108) shown in FIG. 1 may be implemented with any of various types of computing devices known in the art, depending on the particular implementation, such as, but not limited to, a desktop computer, a laptop computer, a personal digital assistant (PDA), a handheld computer, or a cellular telephone. The computing devices typically communicate via a communications network, which may be wired or wireless.

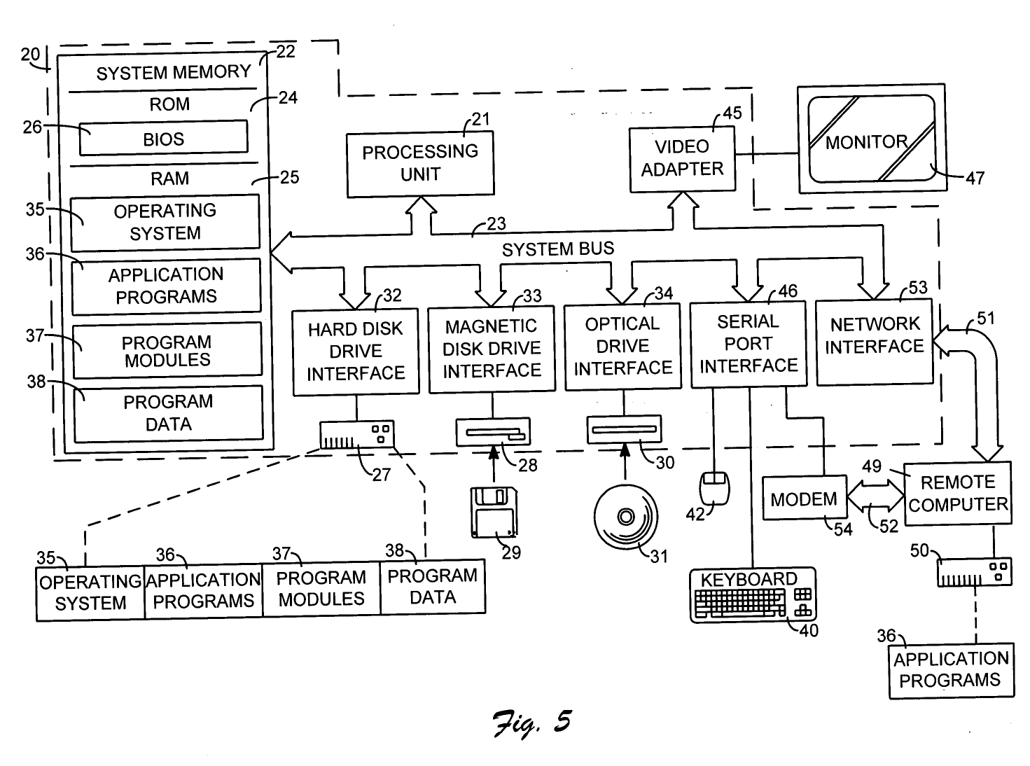

In addition, the computing devices may be arranged in any convenient configuration, such as, but not limited to client/server and peer-to-peer configurations. Modules shown in FIG. 1 can be implemented in software or hardware or any combination of software or hardware. FIG. 5, discussed in detail below, illustrates a computing environment that may be used to implement the computing devices, applications, program modules, networks, processes and data discussed with respect to FIG. 1.

Exemplary Operations

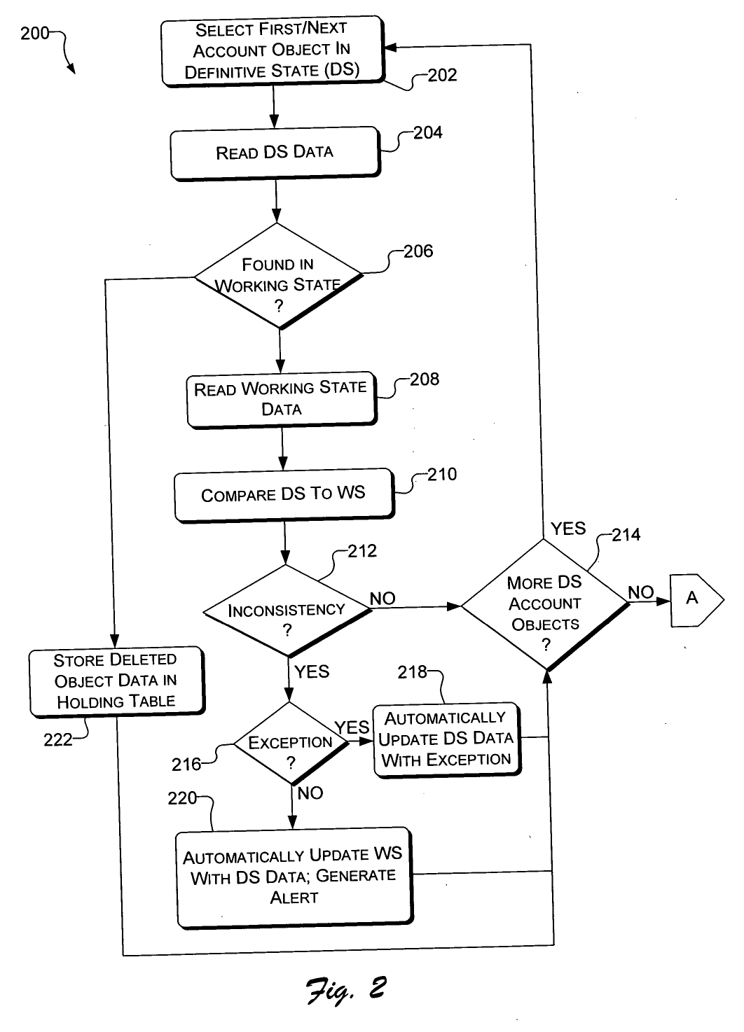

FIG. 2 illustrates an exemplary algorithm for checking a working state of an identity store for errors. In the implementation shown, the algorithm 200 automatically detects and corrects inconsistencies between account objects in a definitive state (DS) of an identity store and account objects in a working state (WS) of an identity store. By making account objects in the WS consistent with account objects in the DS, a level of system security can be achieved. The algorithm 200 may be carried out by the system 100 shown in FIG. 1. Alternatively, the algorithm 200 may be carried out by systems other than the system shown in FIG. 1.

At a predetermined time, the working state of the identity store will be analyzed with respect to a definitive state of the identity store. Initially, a selecting operation 202 selects the first account object in the DS of the identity store. A reading operation 204 then reads the account object data corresponding to the selected account object. The reading operation 204 reads attributes of the account object, such as, but not limited to, user name, password, user title, security access level, and so on.

A determining operation 206 determines whether an account object corresponding to the selected account object is found in the WS of the identity store. The determining operation 206 attempts to find an account object in the WS that has the same attribute as the account object selected from the DS. For example, the determining operation 206 may search for an account object in the WS that has the same user name.

If the determining operation 206 finds an account object in the WS that corresponds to the account object selected from the DS, the algorithm 200 branches “YES” to a reading operation 208. The reading operation 208 reads attribute data for the account object in the WS. A comparing operation 210 compares the attributes for the account object in the DS with the corresponding attributes of the account object in the WS. For example, the comparing operation 210 typically compares the user names, password, title, security access level of both account objects.

A determining operation 212 determines whether any inconsistencies exist between attributes of the DS account object and the WS account object. An inconsistency is any difference between the account objects, such as, but not limited to, a difference in the setting of corresponding attributes, or a missing attribute where the other account object includes an attribute. If the determining operation 212 determines that there are no inconsistencies, the algorithm 200 branches “NO” to a determining operation 214 that determines whether anymore account objects need to be analyzed in the DS of the identity store.

If more account objects need to be analyzed, the algorithm branches “YES” back to the selecting operation 202. The selecting operation 202 then selects the next account object for analysis. After the next account object is selected, the algorithm 200 proceeds as described above.

If in the determining operation 212 an inconsistency is identified between a WS account object and a DS account object, the algorithm 200 branches “YES” to another determining operation 216. The determining operation 216 determines whether an exception exists that explains the inconsistency. Exceptions are stored in a table that can be accessed during the determining operation 216.

If an exception exists, the algorithm 200 branches “YES” to an updating operation 218. The updating operation 218 automatically updates the account object in the DS with the exception data. This may involve changing an attribute of the DS account object to be in accordance with the exception or the corresponding attribute of the WS account object.

If an exception does not exist, the algorithm 200 branches “NO” from determining operation 216 to another updating operation 220. The updating operation 220 automatically updates the account object in the WS of the identity store with the attributes of the account object in the DS of the identity store. As a result, the WS account object will be consistent with the DS account object. The updating operation 220 may be considered a reverting operation when the WS is reverted to a prior state. An alert may also be generated in the updating operation 220 that notifies an administrator or other user that an inconsistency has been identified. The alert may be sent via email or other applicable communications mechanism.

Referring again to the determining operation 206, if an account object corresponding to the selected DS account object is not found in the WS of the identity store, the algorithm 200 branches “NO” to a storing operation 222. The storing operation 222 stores the selected DS account object in a holding table with an indicator that the account object was deleted from the WS of the identity store. Later, an administrator can determine whether the deleted account object should be recreated in the WS of the identity store.

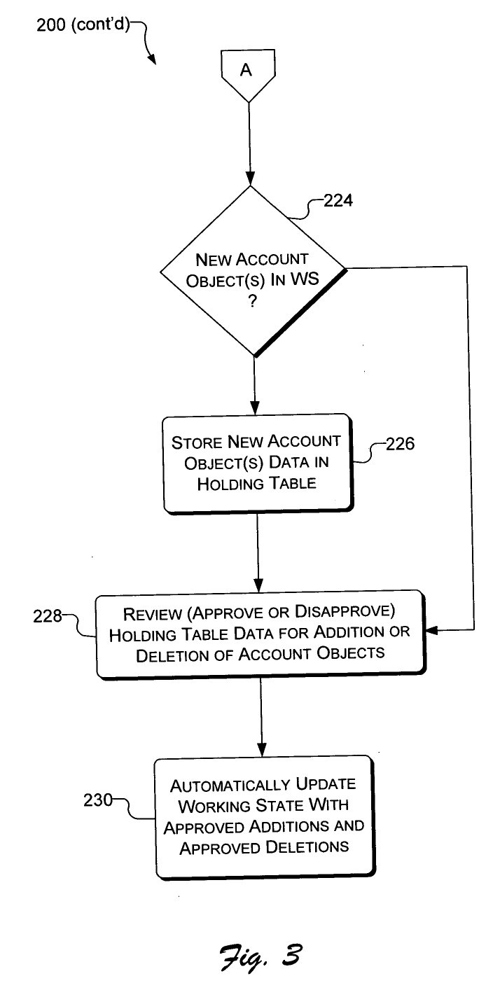

Referring again to the determining operation 214, if it is determined that no more account objects need to be analyzed from the DS, the algorithm branches “NO” to another determining operation 224 (FIG. 3). The determining operation 224 identifies any account objects in the WS of the identity store for which corresponding account objects do not exist in the DS of the identity store. Any account object in the WS that does not have a corresponding account object in the DS is considered a new account object.

If the determining operation 224 identifies any new account objects in the WS, the algorithm 200 branches “YES” to a storing operation 226. The storing operation 226 stores the new account object in the holding table with an indicator that the account object is new. If the determining operation 224 does not identify any new account objects, or after the storing operation 226, a reviewing operation 228 reviews the account objects in the holding table.

In the reviewing operation 228 an administrator approves and/or disapproves of adding deleted account objects into the WS of the identity store or deleting new user accounts from the WS of the identity store. After the reviewing operation 228, an updating operation 230 automatically updates the WS of the identity store with the approved additions and deletions.

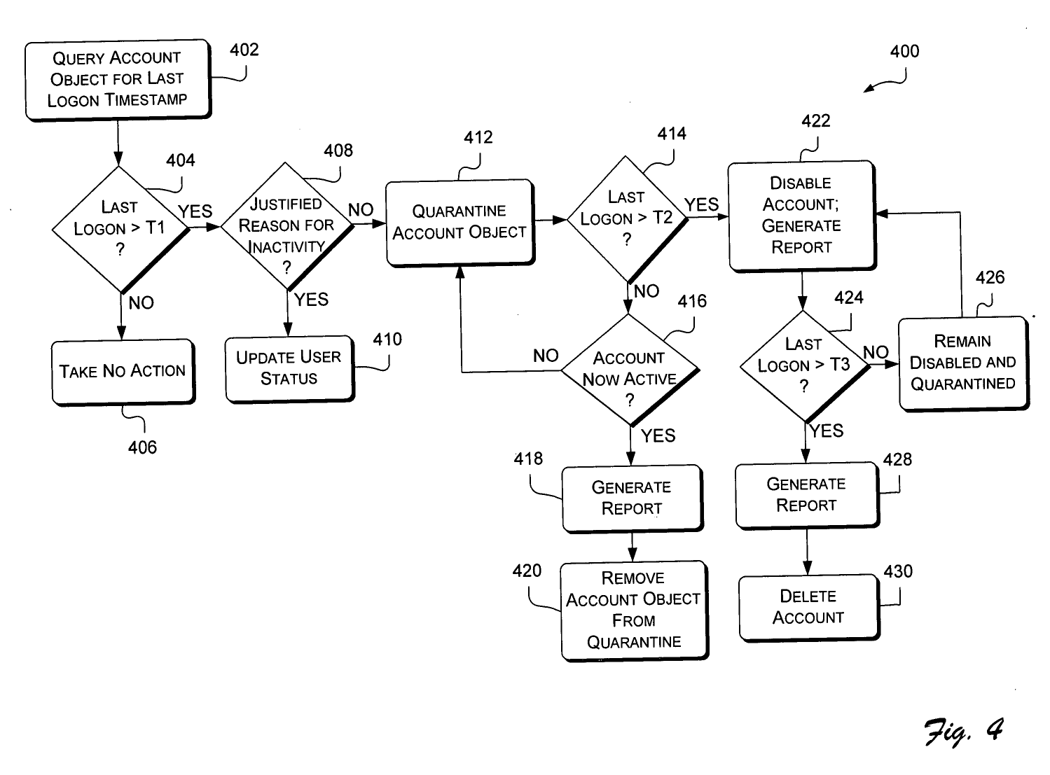

FIG. 4 illustrates an exemplary lifecycle management algorithm 400 for managing the lifecycles of one or more objects in an identity store. In the particular implementation shown, the lifecycle management algorithm 400 manages the lifecycles of account objects. Managing the lifecycles of account objects generally involves determining the manner in which an account object is used in the working state of the identity store, and adjusting the lifecycle of account object based on the manner of usage. The lifecycle management algorithm 400 may be carried out by the system 100 shown in FIG. 1. Alternatively, the lifecycle management algorithm 400 may be carried out by systems other than the system 100.

Initially, a querying operation 402 queries a working state account object to determine inactivity. In accordance with one implementation, the last logon timestamp indicates the last time (e.g., date, time of day) that the corresponding user logged onto the network. A determining operation 404 determines whether the manner of using the selected user account indicates a base level of inactivity. In the implementation shown, the determining operation 404 determines whether the time since the last logon time is greater than a first specified length of time (T1). If the time since the last logon is not greater than T1, the algorithm 400 branches “NO” to a taking operation 406, wherein no action is taken with respect to the selected account object.

If the time since the last logon time is greater than T1, the algorithm 400 branches “YES” to another determining operation 408. The determining operation 408 determines whether the reason for the inactivity in use of the selected user account is justified. An example of justified inactivity is inactivity that is the result of the user being on a leave of absence. Other justified reasons for inactivity may exist. If the inactivity is justified, the algorithm 400 branches “YES” to an updating operation 410. The updating operation 410 updates a user status table with the status of the user.

If the reason for the inactivity is not determined to be justified, the algorithm 400 branches “NO” to a quarantining operation 412. The quarantining operation 412 places the account object in a temporary state in which the account object can be monitored for user activity. The system moves the account object into a quarantine container in disabled state. There it stays in this disabled state for a configurable time. After the account object is quarantined, a determining operation 414 determines whether the time since the last logon is greater than a second specified length of time (T2). If the time since the last logon is not greater than T2, the algorithm branches “NO” to another determining operation 416.

The determining operation 416 determines whether the account object has become active (e.g., the user has logged into his/her account). If the account object has not become active, the algorithm 400 branches “NO” back the quarantining operation 412 in which the account object remains in quarantine. The quarantining operation 412, the determining operation 414, and the determining operation 416. Once in a quarantine state, it only reacts to two conditions. These conditions are the Life-Time Timer expires (final action on the Object, e.g. deletion) and Object changes in such a way that it triggers to get out of quarantine, (e.g. user logs on again). This gets it back to the normal life-cycle, and might trigger an audit, why it was ever quarantined.

Accordingly, if in the determining operation 416 it is determined that the account object has become active, the algorithm branches “YES” to a generating operation 418. The generating operation 418 generates a report including data that is descriptive of the account object and the reasons for quarantine and removal from quarantine. A removing operation 420 removes the account object from quarantine.

However, if the enough time passes without reactivation of the user account, such that the time since the last logon time becomes greater than TS, the algorithm 400 branches “YES” from the determining operation 414 to a disabling operation 422. The disabling operation 422 disables the user account. A report may also be generated that describes the reasons for disabling the user account. When the account object is disabled, the user is typically required to take additional steps to re-enable the user account, such as, for example, by requesting that an information technology administrator re-enable the user account.

Another determining operation 424 determines whether the time since the last logon time is greater than a third specified time (T3). If the time since the last logon time is not greater than T3, the algorithm branches “NO” to a remaining operation 426. The remaining operation 426 simply keeps the account object quarantined and disabled. The algorithm 400 then returns to the disabling operation 422. The disabling operation 422, determining operation 424 and the remaining operation 426 continue to loop until either time passes such that the time since the last logon is greater than T3, or the user takes the required action to get his/her account re-enabled and login.

If the user does not take action to re-enable his/her account and does not login during the looping process and the time since the last logon becomes greater than T3, the algorithm 400 branches from the determining operation 424 to a generating operation 428. The generating operation 428 generates a report describing the account object and reasons for quarantine, disablement, and deletion of the user account. A deleting operation 430 then deletes the user account.

Exemplary Computing Device

With reference to FIG. 5, an exemplary system for implementing the operations described herein includes a general-purpose computing device in the form of a conventional personal computer 20, including a processing unit 21, a system memory 22, and a system bus 23. System bus 23 links together various system components including system memory 22 and processing unit 21. System bus 23 may be any of several types of bus structures including a memory bus or memory controller, a peripheral bus, and a local bus using any of a variety of bus architectures. System memory 22 includes read only memory (ROM) 24 and random access memory (RAM) 25. A basic input/output system 26 (BIOS), containing the basic routine that helps to transfer information between elements within the personal computer 20, such as during start-up, is stored in ROM 24.

As depicted, in this example personal computer 20 further includes a hard disk drive 27 for reading from and writing to a hard disk (not shown), a magnetic disk drive 28 for reading from or writing to a removable magnetic disk 29, and an optical disk drive 30 for reading from or writing to a removable optical disk 31 such as a CD ROM, DVD, or other like optical media. Hard disk drive 27, magnetic disk drive 28, and optical disk drive 30 are connected to the system bus 23 by a hard disk drive interface 32, a magnetic disk drive interface 33, and an optical drive interface 34, respectively. These exemplary drives and their associated computer-readable media provide nonvolatile storage of computer readable instructions, data structures, computer programs and other data for the personal computer 20.

Although the exemplary environment described herein employs a hard disk, a removable magnetic disk 29 and a removable optical disk 31, it should be appreciated by those skilled in the art that other types of computer readable media which can store data that is accessible by a computer, such as magnetic cassettes, flash memory cards, digital video disks, random access memories (RAMs), read only memories (ROMs), and the like, may also be used in the exemplary operating environment.

A number of computer programs may be stored on the hard disk, magnetic disk 29, optical disk 31, ROM 24 or RAM 25, including an operating system 35, one or more application programs 36, other programs 37, and program data 38. A user may enter commands and information into the personal computer 20 through input devices such as a keyboard 40 and pointing device 42 (such as a mouse).

Other input devices (not shown) may include a camera, microphone, joystick, game pad, satellite dish, scanner, or the like. These and other input devices are often connected to the processing unit 21 through a serial port interface 46 that is coupled to the system bus, but may be connected by other interfaces, such as a parallel port, game port, a universal serial bus (USB), etc.

A monitor 47 or other type of display device is also connected to the system bus 23 via an interface, such as a video adapter 45. In addition to the monitor, personal computers typically include other peripheral output devices (not shown), such as speakers and printers.

Personal computer 20 may operate in a networked environment using logical connections to one or more remote computers, such as a remote computer 49. Remote computer 49 may be another personal computer, a server, a router, a network PC, a peer device or other common network node, and typically includes many or all of the elements described above relative to the personal computer 20.

The logical connections depicted in FIG. 5 include a local area network (LAN) 51 and a wide area network (WAN) 52. Such networking environments are commonplace in offices, enterprise-wide computer networks, Intranets and the Internet.

When used in a LAN networking environment, personal computer 20 is connected to local network 51 through a network interface or adapter 53. When used in a WAN networking environment, the personal computer 20 typically includes a modem 54 or other means for establishing communications over the wide area network 52, such as the Internet. Modem 54, which may be internal or external, is connected to system bus 23 via the serial port interface 46.

In a networked environment, computer programs depicted relative to personal computer 20, or portions thereof, may be stored in a remote memory storage device. It will be appreciated that the network connections shown are exemplary and other means of establishing a communications link between the computers may be used.

Various modules and techniques may be described herein in the general context of computer-executable instructions, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

An implementation of these modules and techniques may be stored on or transmitted across some form of computer-readable media. Computer-readable media can be any available media that can be accessed by a computer. By way of example, and not limitation, computer-readable media may comprise “computer storage media” and “communications media.”

“Computer storage media” includes volatile and non-volatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer-readable instructions, data structures, program modules, or other data in a modulated data signal, such as carrier wave or other transport mechanism. Communication media also includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer-readable media.

Although the exemplary operating embodiment is described in terms of operational flows in a conventional computer, one skilled in the art will realize that the present invention can be embodied in any platform or environment that processes and/or communicates video signals. Examples include both programmable and non-programmable devices such as hardware having a dedicated purpose such as video conferencing, firmware, semiconductor devices, hand-held computers, palm-sized computers, cellular telephones, and the like.

Although some exemplary methods and systems have been illustrated in the accompanying drawings and described in the foregoing Detailed Description, it will be understood that the methods and systems shown and described are not limited to the particular implementation described herein, but rather are capable of numerous rearrangements, modifications and substitutions without departing from the spirit set forth herein.

What is claimed is:

1. A method for protecting a system from inappropriate access through a user account, the method comprising:
detecting an inconsistency between an account object in a definitive state repository and a corresponding account object in a working state repository; and
generating an alert and a report based on the detecting of the inconsistency.

2. A method as recited in claim 1 further comprising automatically reverting the account object in the working state repository based on the corresponding account object in the definitive state repository.

3. A method as recited in claim 2 further comprising notifying an operator of the reverting.

4. A method as in claim 1 further comprising:
identifying a new account in the working state repository; and
storing information descriptive of the new account.

5. A method as recited in claim 1 further comprising:
identifying an account object in the definitive state repository that has been deleted from the working state repository; and
storing information descriptive of the deleted account object.

6. A method as recited in claim 5 further comprising notifying an operator of the deleted account object.

7. A method as recited in claim 1 further comprising:
determining whether an exception exists for the inconsistency; and
automatically reverting the account object in the working state repository only if an exception does not exist for the inconsistency.

8. A method as recited in claim 1 further comprising:
determining whether an exception exists for the inconsistency; and
automatically updating the account object in the definitive state repository in accordance with an exception if an exception does exist for the inconsistency.

9. A system comprising:
a working state of an identity store having an account object;
definitive state data having an account object in a known state; and
a consistency checking module operable to determine whether the account object in the working state is consistent with the account object in the definitive state.

10. A system as recited in claim 9 further comprising an updating module operable to update the account object in the working state with the data from the account object in the definitive state.

11. A system as recited in claim 9 further comprising a lifecycle management module operable to determine a period of inactivity related to use of the account object in the working state.

12. A system as recited in claim 1 1 wherein the lifecycle management module is further operable to disable the account object in the working state, quarantine the account object in the working state, or delete the account object in the working state, if the period of inactivity is greater than a specified period of time.

13. A system as recited in claim 9 further comprising an alert module operable to alert a user if an inconsistency is identified.

14. A system as recited in claim 11 further comprising a lifecycle alerting module operable to alert a user based on one or more events related to lifecycle management of the account object in the working state.

15. A system as recited in claim 14 wherein the one or more events include at least one of:
quarantining the account object;
disabling the account object;
deleting the account object.

16. A system as recited in claim 9 wherein the consistency checking module is further operable to identify a new account object in the working state.

17. A system as recited in claim 9 wherein the consistency checking module is further operable to identify a deleted account object in the definitive state data, the deleted account object being deleted from the working state.

18. A system as recited in claim 9 further comprising a holding table identifying new account objects and deleted account objects.

19. A system as recited in claim 9 further comprising an exception table including one or more exceptions to rules related to account objects.

20. A system comprising:
a working state of an identity store including an account object;
a definitive state of the identity store including a corresponding account object; and
means for determining whether the corresponding account object in the definitive state is consistent with the account object in the working state.
